(19) United States
(12) Patent Application Publication
(10) Pub. No.: US 2017/0347251 A1
(43) Pub. Date: Nov. 30, 2017

(54) SIGNALING METHOD IN MOBILE COMMUNICATION CORE NETWORK AND SYSTEM THEREOF

(71) Applicant: ELECTRONICS AND TELECOMMUNICATIONS RESEARCH INSTITUTE, Daejeon (KR)

(72) Inventors: Changki KIM, Daejeon (KR); Yoo Hwa KANG, Daejeon (KR); No Ik PARK, Daejeon (KR); Young Il CHOI, Daejeon (KR); Jeoung Lak HA, Daejeon (KR)

(21) Appl. No.: 15/600,896

(22) Filed: May 22, 2017

(30) Foreign Application Priority Data
May 26, 2016 (KR) 10-2016-0065023

(51) Int. Cl. H04W 4/20; H04W 88/04; H04W 72/04

(52) U.S. Cl. CPC H04W 4/20; H04W 72/0413; H04W 88/04

(57) ABSTRACT

A signaling method in a mobile communication core network and a system thereof. The signaling method in a mobile communication core network includes: receiving, by a traffic controller, an initial attach request from a terminal in a software defined network (SDN) based mobile communication core network; allocating, by the traffic controller, a tunnel identifier for a tunnel establishment between a base station and a traffic transmitter or between traffic transmitters in response to the initial attach or a service request of the terminal; and transmitting, by the traffic controller, the allocated tunnel identifier to the traffic transmitter and the base station.

### CROSS-REFERENCE TO RELATED APPLICATION

This application claims priority to and the benefit of Korean Patent Application No. 10-2016-0065023, filed in the Korean Intellectual Property Office on May 26, 2016, the entire content of which is incorporated herein by reference.

### BACKGROUND OF THE INVENTION

### 1. Field of the Invention

The present invention relates to a signaling technology in a mobile communication core network.

### 2. Description of Related Art

A Software-Defined network (SDN) (hereinafter, referred to as SDN) is a technology that separates a control plane and a data plane from each other and controls the data plane using one controller in the control plane. In the SDN scheme, the data plane is simply responsible for a traffic forwarding, and a central controller is responsible for a control of the traffic forwarding. In particular, the controller provides various application programming interfaces (APIs) through a northbound API and enables a programming using the various APIs to be able to perform various traffic controls based on network information. An OpenFlow protocol, which is a protocol that supports an operation of the SDN as described above, is a southbound protocol that transmits transmission information between the controller and a switch and transmits a state of the switch, traffic information, or the like to the controller.

In order to efficiently operate a network by providing flexibility and scalability in terms of CAPAX/OPEX for mobile communication providers, such SDN technology may be applied to a mobile communication core network. Above all, the most attractive aspect of the SDN is the ability to create and operate the network in the way that a user wants, as the network which is closed and dependent on a vendor is opened and standardized. Accordingly, commercial products (H/W and S/W) in which the mobile communication core network is established based on the SDN have been released by mobile communication core network equipment, manufacturers. This applies the SDN technology to the mobile communication core network without changing existing terminals and base stations, and also enables interworking with the mobile communication core network to which the SDN is not applied.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a signaling method in a mobile communication core network and a system thereof having advantages of having flexibility in complexity of a signaling processing and a network failure processing due to a separation of a data plane and a control plane in an SDN based next-generation mobile communication core network, and effectively performing the signaling processing and the network failure processing.

An exemplary embodiment of the present invention provides a signaling method in a mobile communication core network including: receiving, by a traffic controller, an initial attach request from a terminal in a SDN based mobile communication core network; allocating, by the traffic controller, a tunnel identifier for a tunnel establishment between a base station and a traffic transmitter or between traffic transmitters according to the initial attach request of the terminal; and transmitting, by the traffic controller, the allocated tunnel identifier to the traffic transmitter and the base station.

The traffic controller may include an edge unified control entity or a mobility management entity, and the traffic transmitter may be an openflow switch.

In the allocating of the tunnel identifier, the traffic controller may allocate a tunnel identifier for downlink traffic and a tunnel identifier for uplink traffic between the base station and the traffic transmitter, respectively.

The traffic controller may include an edge unified control entity and a software defined network (SDN) controller, and the signaling method in the mobile communication core network may further include transmitting, by the edge unified control entity allocating the tunnel identifier, a traffic transmitter allocation request including uplink and downlink tunnel identifiers to the SDN controller; allocating, by the SDN controller, the traffic transmitter; and receiving, by the edge unified control entity, a traffic transmitter allocation response including information on the allocated traffic transmitter from the SDN controller. The signaling method may further include updating, by the SDN controller allocating the traffic transmitter, a forward table, while transmitting the uplink and downlink tunnel identifiers received from the edge unified control entity to the traffic transmitter. The signaling method may further include transmitting, by the edge unified control entity receiving the traffic transmitter allocation response, uplink and downlink tunnel identifier information to the base station.

The traffic controller may include a mobility management entity, a gateway controller, and a SDN controller, and the signaling method in the mobile communication core network may further include: transmitting, by the mobility management entity, a create session request including uplink and downlink tunnel identifiers to the gateway controller; and receiving, by the mobility management entity, a create session response from the gateway controller. The signaling method may further include transmitting, by the mobility management entity receiving the create session response, uplink and downlink tunnel identifier information to the base station.

The traffic controller may include a mobility management entity, a gateway controller, and a SDN controller, and the signaling method in the mobile communication core network may further include: receiving, by the gateway controller, a create session request including a tunnel identifier from the mobility management entity; requesting, by the gateway controller receiving the create session request, a traffic transmitter allocation while transmitting the tunnel identifier to the SDN controller; and receiving, by the gateway controller, a traffic transmitter allocation response from the SDN controller, when the SDN controller allocates the traffic transmitter. The signaling method may further include updating, by the SDN controller allocating the traffic transmitter, a forward table, while transmitting the tunnel identifier received from the gateway controller to the traffic transmitter.

Another embodiment of the present invention provides a signaling method in the mobile communication core network, including: receiving, by a traffic controller, a service request through a base station from a terminal in a software defined network (SDN) based mobile communication core network; allocating, by the traffic controller, a tunnel identifier for a tunnel establishment between a base station and a traffic transmitter or between traffic transmitters in response to the service request of the terminal; and transmitting, by the traffic controller, the allocated tunnel identifier to the traffic transmitter and the base station to which a traffic is to be transmitted.

The traffic controller may include an edge unified control entity and a SDN controller, and the signaling method in the mobile communication core network may further include transmitting, by the edge unified control entity allocating uplink and downlink tunnel identifiers, a traffic transmitter allocation request including the uplink and downlink tunnel identifiers to the SDN controller; allocating, by the SDN controller, the traffic transmitter; and receiving, by the edge unified control entity, a traffic transmitter allocation response including information on the allocated traffic transmitter from the SDN controller. The signaling method may further include updating, by the SDN controller allocating the traffic transmitter, a forward table, while transmitting the uplink and downlink tunnel identifiers to the traffic transmitter. The signaling method may further include transmitting, by the edge unified control entity receiving the traffic transmitter allocation response, previously allocated uplink and downlink tunnel identifier information to the base station.

The traffic controller may include a mobility management entity, a gateway controller, and a SDN controller, and the signaling method in the mobile communication core network may further include: transmitting, by the mobility management entity, a modify bearer request including the tunnel identifier to the gateway controller; requesting, by the gateway controller receiving the modify bearer request, a traffic transmitter allocation while transmitting the tunnel identifier to the SDN controller; allocating, by the SDN controller, the traffic transmitter; and receiving, by the gateway controller, the traffic transmitter allocation response from the SDN controller. The signaling method may further include updating, by the SDN controller allocating the traffic transmitter, a forward table, while transmitting the tunnel identifier received from the gateway controller to the traffic transmitter.

Another embodiment of the present invention provides a mobile communication core network system including: a traffic controller receiving an initial attach request or a service request from a terminal in a software defined network (SDN) based mobile communication core network and allocating a tunnel identifier for a tunnel establishment between a base station and a traffic transmitter or between traffic transmitters; and the traffic transmitter receiving the allocated tunnel identifier from the traffic controller and transmitting a traffic through the set tunnel.

The traffic controller may include an edge unified control entity allocating a tunnel identifier for downlink traffic and a tunnel identifier for uplink traffic between the base station and the traffic transmitter in response to the initial attach request or the service request of the terminal; and a SDN controller receiving a traffic transmitter allocation request including the uplink and downlink tunnel identifiers from the edge unified control entity, allocating a traffic transmitter, and transmitting a traffic transmitter allocation response to the edge unified control entity.

The traffic controller may include a mobility management entity each allocating a tunnel identifier for downlink traffic and a tunnel identifier for uplink traffic between the base station and the traffic transmitter according to the initial attach request of the terminal; a gateway controller receiving a create session request including the tunnel identifier from the mobility management entity and allocating an IP address of the terminal to transmit a create session response to the mobility management entity; and a SDN controller receiving a traffic transmitter allocation request from the gateway controller and allocating the traffic transmitter to control the traffic.

The traffic controller may include a mobility management entity each allocating a tunnel identifier for downlink traffic between the base station and the traffic transmitter according to the service request of the terminal; a gateway controller receiving a modify bearer request including the tunnel identifier from the mobility management entity and transmitting a modify bearer response including an IP address of the terminal to the mobility management entity; and a SDN controller receiving a traffic transmitter allocation request from the gateway controller and allocating the traffic transmitter to control the traffic.

### BRIEF DESCRIPTION OF THE DRAWINGS

FIG. 1 is a structure diagram of an SDN based mobile communication core network according to an exemplary embodiment of the present invention;

FIG. 2 is a structure diagram of an SDN based mobile communication core network according to another exemplary embodiment of the present invention;

FIG. 3 is a flowchart illustrating a call flow of the SDN based mobile communication core network at the time of Initial Attach Request of a user equipment (UE) according to an exemplary embodiment of the present invention;

FIG. 4 is a flowchart illustrating a call flow of the SDN based mobile communication core network at the time of Service Request of a UE according to an exemplary embodiment of the present invention;

FIG. 5 is a flowchart illustrating a call flow of the SDN based mobile communication core network at the time of Initial Attach Request of a UE according to another exemplary embodiment of the present invention; and

FIG. 6 is a flowchart illustrating a call flow of the SDN based mobile communication core network at the time of Service Request of a UE according to another exemplary embodiment of the present invention.

### DETAILED DESCRIPTION OF THE EMBODIMENTS

The advantages and features of the present invention, and the method of achieving them will be apparent with reference to embodiments described in detail below together with the accompanying drawings. However, the present invention is not limited to the exemplary embodiments disclosed below, but may be embodied in different various forms, rather the present exemplary embodiments are provided so that the present disclosure is thorough and the scope of the present invention is fully conveyed to those skilled in the art, and the present invention is defined only by the scope of the claims. Like reference numerals refer to like elements throughout the specification.

In the following description of the present invention, a detailed description of known functions and configuration will be omitted when it may unnecessarily obscure the subject matter of the present invention, and the following terms are defined in consideration of the functions in the exemplary embodiments of the present invention and may vary depending on a user, intention of an operator, or custom. Therefore, the definitions thereof should be based on the contents throughout the specification.

Combinations of the respective blocks of the accompanying block diagrams and the steps of the accompanying flowcharts may also be performed by computer program instructions (execution engines), and since the computer program instructions may be embedded in a processor of a general-purpose computer, a special purpose computer or other programmable data processing devices, the instructions performed by the processor of the computer or other programmable data processing devices generates means for performing functions described in the respective blocks of the block diagrams or the respective steps of the flowcharts.

Since the computer program instructions may also be stored in a computer usable or computer readable memory that may be directed to the computer or other programmable data processing devices to implement the functions in a specific manner, the instructions stored in the computer usable or computer readable memory may also produce a manufacture article containing instruction means for performing the functions described in the respective blocks of the block diagrams or the respective steps of the flowcharts.

In addition, since the computer program instructions may also be embodied on the computer or other programmable data processing devices, a series of operation steps may be performed on the computer or other programmable data processing devices to generate processes executed by the computer. As a result, the instructions performing the computer or other programmable data processing devices may also provide steps for executing the functions described in the respective blocks of the block diagrams or the respective steps of the flowcharts.

Further, each block or each step may represent a portion of a module, a segment, or a code including one or more executable instructions for executing specific logical functions, and it should be noted that in some alternative exemplary embodiments, the functions mentioned in the blocks or the steps occur out of the order. For example, two successively shown blocks or steps may also be actually concurrently performed, and the blocks or steps may also be performed in a reverse order of the corresponding function, as needed. Hereinafter, exemplary embodiments of the present invention will be described in detail with reference to the accompanying drawings.

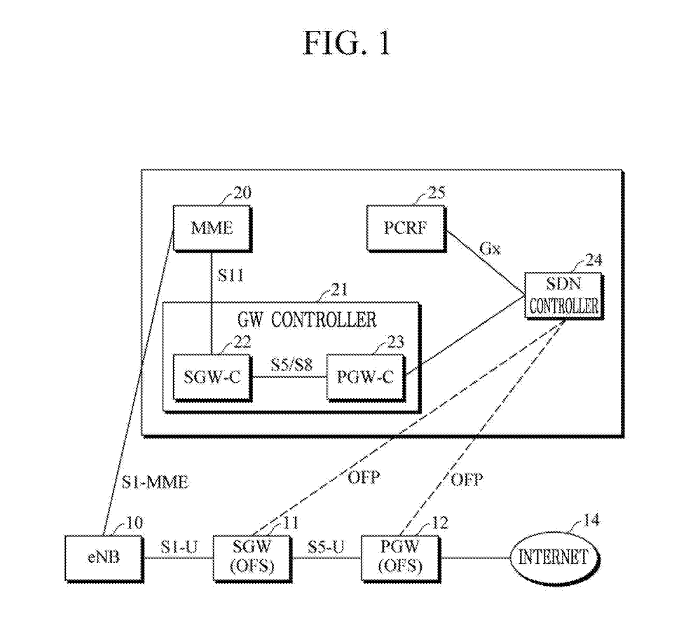

FIG. 1 is a structure diagram of a software defined network (SDN) based mobile communication core network according to an exemplary embodiment of the present invention.

A mobile communication core network of FIG. 1 may be an existing long term evolution (LTE) core network. Referring to FIG. 1, an SDN based mobile communication core network includes a data plane and a control plane. The data plane includes an evolved NodeB 10, a serving gateway (SGW) (hereinafter, referred to as SGW) 11, a PDN gateway (PGW) (hereinafter, referred to as PGW) 12, and Internet 14. The control plane includes a mobility management entity (MME) (hereinafter, referred to as MME) 20, a gateway controller (hereinafter, referred to as GW controller) 21, an SDN controller 24, and a policy and charging rules function (PCRF) (hereinafter, referred to as PCRF) 25. The GW controller 21 may include an SGW controller (SGW-C) (hereinafter, referred to as SGW-C) 22 and a PGW controller (PGW-C) (hereinafter, referred to as PGW-C) 23. The SGW 11 and the PGW 12 may be plural, and is an openflow switch (OFS) (hereinafter, referred to as OFS).

The packets sent from the UE are transmitted to the Internet 14 via the SGW 11 and the PGW 12 from the eNB 10. The packets are transmitted through an S1 GTP tunnel between the eNB 10 and the SGW 11, and are transmitted through an S5 GTP tunnel between the SGW 11 and the PGW 12.

An openflow (OFP) based SDN technology has been initially and mainly applied to switches connecting servers within a data center to each other, and a method of utilizing openflow in the LTE network which is a 4G mobile communication core network has been proposed. However, the openflow was mainly applied when an evolved packet core which is the LTE core network is virtualized, or a separation of the control plane and the data plane, which is an SDN based basic concept, has been applied without changing a function entity of the existing LTE core network. Thereby, there are a traffic controller which is responsible for a control and switches which are responsible for transmission of a traffic flow, and an interface between the traffic controller and the switches is standardized, such that virtualization configuration may be easily performed and an object of reducing CAPEX/OPEX may be ultimately achieved.

However, the separation of the traffic controller and the traffic transmitter without changing a structure of the LTE core network causes an increase in the number of openflow signaling, and further, as the number of traffic controllers is increased, complex signaling between the traffic controllers is also increased.

Meanwhile, in the LTE core network structure (also including SDN based and non-SDN structure), GTP tunnel endpoint ID (TEID) for an S1 bearer between the eNB 10 and the SGW 11, and an S5 bearer between the SGW 11 and the PGW 12 is allocated and released by each individual node. In this case, when a fault occurs in one node and a change into a new node is performed, it is required to receive tunnel identifier from the new node and inform a neighboring node of the tunnel identifier in a process of moving an existing bearer and establishing a new bearer. Therefore, it may not be flexible for fast fault recovery. In particular, since the eNB 10 allocates a tunnel identifier for a downlink traffic, a large amount of additional signaling is required.

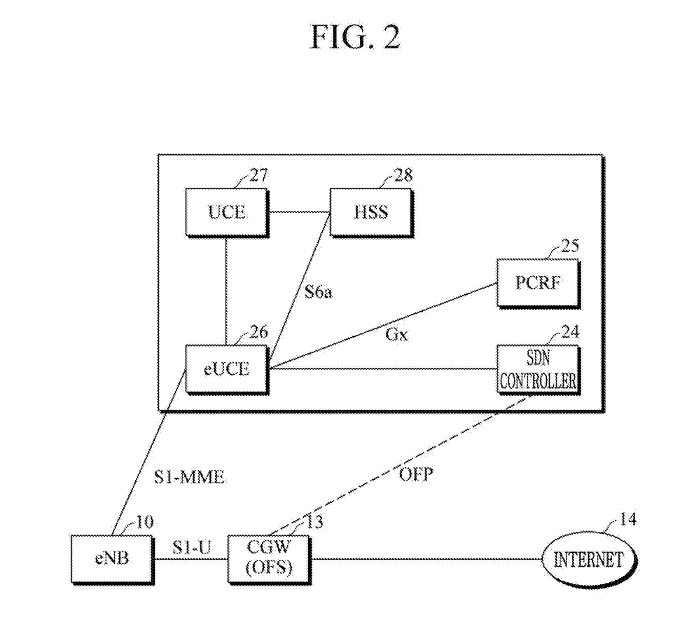

The present invention aims to reduce a complex signaling process caused by applying the SDN technology to the LTE core network in the SDN based LTE core network structure according to the related art. In particular, the present invention selects to reduce the number of initial attach request and service request signaling procedure of the terminal and signaling latency and to save resources of the core network by allocating TEID in a control plane node and managing TEID in a centralized manner, not distributing and allocating TEID in a data plane node (eNB 10, SGW 11, PGW 12) processing each traffic, when a tunnel for traffic transmission between the eNB 10, and the SGW 11 and the PGW 12 is set in the SDN based LTE core network structure. Hereinafter, an SDN based 5G core network structure having characteristics described above will be described below with reference to FIG. 2.

FIG. 2 is a structure diagram of an SDN based mobile communication core network according to another exemplary embodiment of the present invention.

A mobile communication core network of FIG. 2 may be a 5G core network. Referring to FIG. 2, the SDN based mobile communication core network includes a data plane and a control plane. The data plane includes an eNB 10 and a converged gateway (CGW) (hereinafter, referred to as CGW) 13, which is an openflow switch (OFS) (hereinafter, referred to as OFS). The control plane includes an edge unified control entity (eUCE) (hereinafter, referred to eUCE) 26, a unified control entity (UCE) (hereinafter, referred to as UCE) 27, a home subscriber server (HSS) (hereinafter, referred to as HSS) 28, a PCRF 25, and an SDN controller 24.

Similar to the SDN based LTE core network, the SDN based 5G core network structure is a structure in which the control plane and the data plane are separated from each other and a function control of the data plane is performed using an openflow interface through the SDN controller 24. For this purpose, the 5G core network defines the eUCE 26 and UCE 27 to perform an MME function in the LTE structure and the control function of the SGW and the PGW, and interworks with the SDN controller 24 to transmit necessary information.

The SDN controller 24 controls all OFSs so that the traffic from the terminal is transmitted to a desired destination.

In addition, 5G core network defines the CGW(OFS) to perform a function of processing various tunnels as well as a GTP tunnel in the LTE network.

The eNB 10, which is a base station (BS), may also be referred to, instead of the eNB 10, as an access point (AP), a radio access station (RAS), a NodeB, a base transceiver station (BTS), a mobile multihop relay (MMR)-BS, or the like, and may also include all or some of functions of the access point, the radio access station, the NodeB, the base transceiver station, the MMR-BS, and the like.

The user equipment (UE) (hereinafter, referred to as UE) is one of terminals used by the user, and the terminal may be referred to as a mobile station (MS), a mobile terminal (MT), a subscriber station (SS), a portable subscriber station (PSS), an access terminal (AT), and the like, other than the UE. Alternatively, the terminal may also include all or some functions of the mobile terminal, the subscriber station, the portable subscriber station, the UE, the access terminal, and the like. Moreover, the terminal means any one or both of the terminal or the user using the terminal. Hereinafter, a case in which the terminal is the UE will be described by way of example for convenience of explanation.

In the SDN based 5G core network according to an exemplary embodiment, the added NEs are the eUCE 26, the UCE 27, and the CGW 13, and functions thereof are as follow. The functions of the HSS 28, the PCRF 25, and the eNB 10 are the same as those in the LTE core network without being changed.

The eUCE 26 is a traffic controller located at an edge of the mobile communication core network, and one eUCE 26 may cover one or more CGWs(OFSs) 13, but one CGW(OFS) 13 may be controlled only by one eUCE 26. The eUCE 26 accommodates the same function as the MME function in the LTE core network, and also performs the GW controller function, which is the SGW-C and PGW-C function of the SDN based LTE core network. Therefore, the eUCE 26 allocates an IP address of the terminal, and performs paging request and packet forwarding functions in an idle state. In addition, the eUCE 26 processes an inter-eNB handover, and transmits a terminal IP address, an eNB IP address, and GTP tunnel information to the SDN controller 24 when the SDN controller 24 requests the terminal IP address, the eNB IP address, and the GTP tunnel information. The UCE 27, which is unified control entity present at the center of the mobile communication core network, processes a control function for the entire network including an inter-CGW handover.

The SDN controller 24 controls and manages the OFSs. The SDN controller 24 interworks with the UCE 27 and the eUCE 26 to obtain mobility information of the terminal, GTP session information, and the like, and sets transmission information of a terminal packet to the OFS through the openflow using the obtained information. In addition, the SDN controller 24 may provide a northbound API, and may interwork with an application as needed to set a packet transmission function to the OFS to process the packet specialized for each application. The SDN controller 24, which is a logical function entity, may also be physically included in the eUCE 26 and may also be independently separated from the eUCE 26.

Hereinafter, initial attach and service request procedures of the terminal will be described based on the SDN based 5G core network defined with reference to FIG. 2 with reference to the drawings described below.

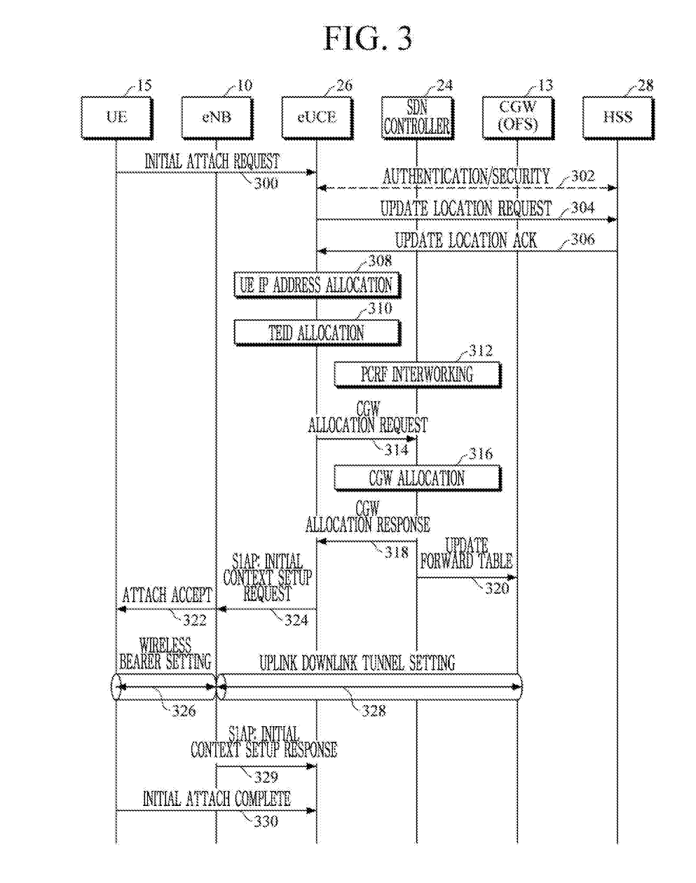

FIG. 3 is a flowchart illustrating a call flow of the SDN based mobile communication core network at the time of Initial Attach Request from a user equipment (UE) according to an exemplary embodiment of the present invention.

The procedure of FIG. 3 may be applied to the core network structure described above with reference to FIG. 2. Referring to FIG. 3, the UE 15 transmits an attach request 300, which is a non-access stratum (NAS) message, to the eUCE 26 for initial attach. The attach request 300 may include international mobile station identity (IMSI) information of the UE 15. The eUCE 26 receiving the attach request 300 interworks with the HSS 28 like the function of the existing MME to perform subscriber authentication and NAS security key setting (Authentication/Security) 302.

Next, the eUCE 26 registers the subscriber in the network, requests the HSS 28 to register the location (Update Location Request) 304 to inform the user what service is available and that a current eUCE 26 manages the corresponding UE 15, and receives a location registration response (Update Location ACK) 306 from the HSS 28. At the time of Update Location Request 304, the eUCE 26 may transmit the IMSI information of the UE 15 to the HSS 28. At the time of Update Location ACK 306, the eUCE 26 may receive QoS profile information, which is a service profile to which the UE 15 subscribes, from the HSS 28.

Next, the eUCE 26 allocates an IP address of the UE 15 and ID of an EPS bearer (UE IP/EPS Bearer ID Allocation) 308, and each allocates eNB TEID (for downlink traffic) and CGW TEID (for uplink traffic), which are tunnel identifiers to establish a tunnel between the eNB 10 and the CGW (OFS) 13 or between the CGWs (OFSs) 13 (310). The SDN controller 24 performs PCRF interworking 312.

Next, if the eUCE 26 transmits a CGW Allocation Request 314 to the SDN controller 24, the SDN controller 24 allocates the CGW (CGW Allocation) 316, and receives a CGW Allocation Response 318 from the SDN controller 24 to be allocated with the CGW. At the time of the CGW Allocation Request 314, the eUCE 26 may transmit the previously allocated eNB TEID and CGW TEID, the eNB IP address, the IMSI, the UE IP address, the eNB ID, and the authenticated QoS information to the SDN controller 24. In addition, at the time of the CGW Allocation Response 318, the eUCE 26 may receive the IP address of the allocated CGW from the SDN controller 24. The SDN controller 24 allocating the CGW updates a forward table (Update Forward Table) 320 while transmitting the eNB TEID, the CGW TEID, and the QoS profile information to the CGW 13.

Meanwhile, the eUCE 26 receiving the CGW Allocation Response message 318 transmits an Attach Accept 322 message to the UE 15 via the eNB 10 through an Initial Context Setup Request message 324, which is an S1AP message. In this case, the UE IP address, the EPS bearer ID and the QoS profile information are transmitted to the UE 15, and the eNB TEID, the CGW TEID, and the CGW IP address information are transmitted to the eNB 10.

Next, the eNB 10 establishes a radio bearer with the UE 15 (326), and establishes an uplink and downlink tunnel for traffic transmission with the CGW(OFS) 13 (328). The eNB 10 transmits an Initial Context Setup Response message 329, which is an S1AP message, to the eUCE 26, and the UE 15 transmits an Attach Complete 330 message to the eUCE 26. In the case of an existing tunnel identifier exchange scheme, the eUCE 26 needs to transmit the eNB TEID, which is tunnel identifier received from the eNB 10 through a Modify Bearer Request message, to the CGW(OFS) 13 through the SDN controller 24, but this part of the procedure is unnecessary in the present invention.

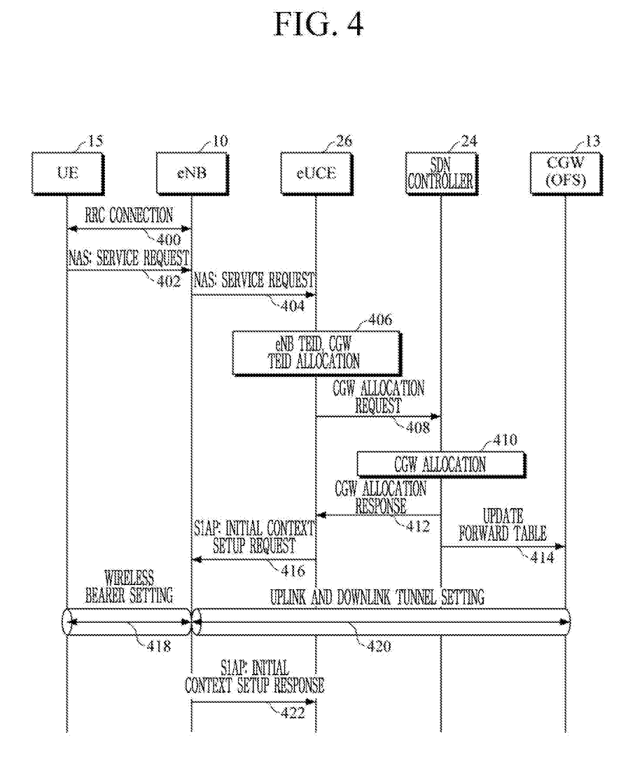

FIG. 4 is a flowchart illustrating a call flow of the SDN based mobile communication core network at the time of Service Request of a UE according to an exemplary embodiment of the present invention.

The procedure of FIG. 4 may be applied to the core network structure described above with reference to FIG. 2. Referring to FIG. 4, after an RRC connection 400 is performed between the UE 15 and the eNB 10, the UE 15 transmits a Service Request 402, 404, which is an NAS message, to the eUCE 26 through the eNB 10. The eUCE 26 receiving the Service Request 404 allocates the CGW TEID (for uplink traffic) and the eNB TEID (for downlink traffic), which are the tunnel identifiers to establish the tunnel between the eNB 10 and the CGW(OFS) 13 or between CGWs(OFSs) 13 for user traffic transmission (406).

Next, if eUCE 26 transmits a CGW allocation request 408 to the SDN controller 24, the SDN controller 24 allocates the CGW (CGW Allocation) 410, and the eUCE 26 receives a CGW Allocation Response 412 from the SDN controller 24 to be allocated with the CGW. At the time of the CGW Allocation Request 408, the eUCE 26 may transmit the previously allocated CGW TEID and eNB TEID, the eNB IP address, the IMSI, the UE IP address, the eNB ID, the authenticated QoS information, and the EPS bearer ID to the SDN controller 24. In addition, at the time of the CGW Allocation Response 412, the eUCE 26 may receive the IP address of the allocated CGW from the SDN controller 24. The SDN controller 24 allocating the CGW updates a forward table (Update Forward Table) 414 while transmitting the CGW TEID, the eNB TEID, the QoS profile information, and the EPS bearer ID received from the eUCE 26 to the CGW 13.

Meanwhile, the eUCE 26 receiving the CGW Allocation Response 412 transmits the an Initial Context Setup Request message 416 including the CGW TEID, the eNB TEID, and the CGW IP address information, which is an S1AP message, to the eNB 10.

Next, the eNB 10 sets a radio bearer with the UE 15 (418), and establishes an uplink and downlink tunnel for traffic transmission with the CGW 13 (420). Finally, the eNB 10 transmits an Initial Context Setup Response message 422, which is an S1AP message, to the eUCE 26. In the case of existing tunnel identifier exchange scheme, the eUCE 26 needs to transmit the eNB TEID received from the eNB 10 through a Modify Bearer Request message, to the CGW 13 through the SDN controller 24, but this part of the procedure is unnecessary in the present invention.

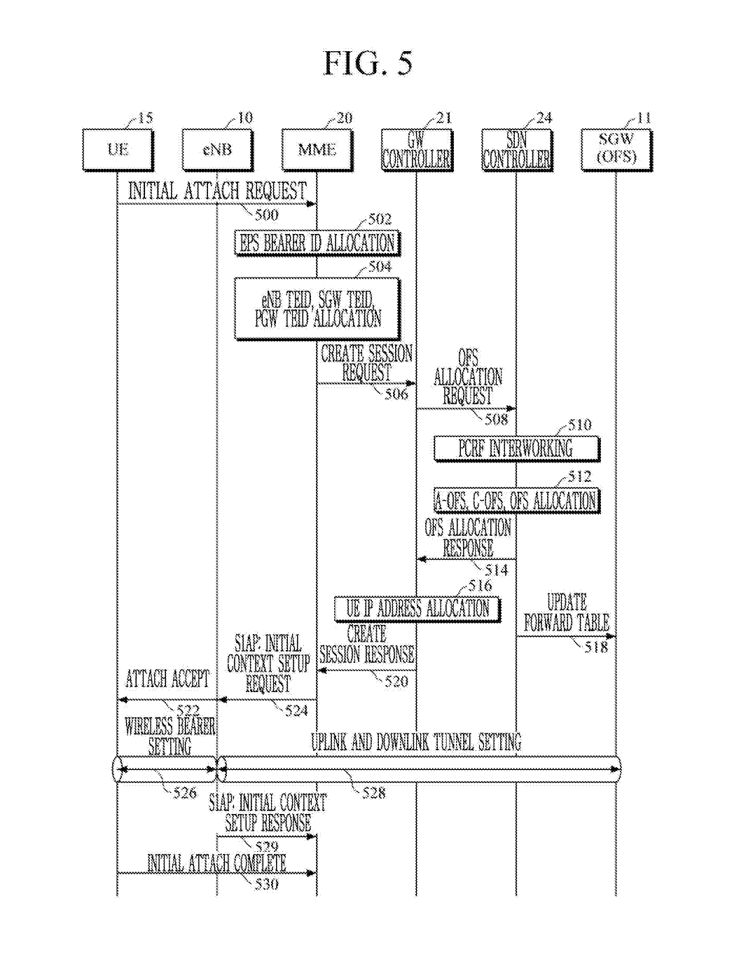

FIG. 5 is a flowchart illustrating a call flow of the SDN based mobile communication core network at the time of Initial Attach Request of a UE according to another exemplary embodiment of the present invention.

The process of FIG. 5 may be applied to the core network structure described above with reference to FIG. 1. Referring to FIG. 5, the control plane includes an MME 20, a GW controller 21, and an SDN controller 24. Interfaces between the MME 20 and the GW controller 21 are existing LTE standard messages. The GW controller 21 may be a system architecture evolution (SAE) GW controller.

A call flow of an initial attach procedure is similar to FIG. 3 except that the eUCE 26 of FIG. 3 includes the MME 20 and the GW controller 21. That is, the allocation of the eNB TEID (for downlink traffic), the SGW TEID (for uplink and downlink traffic), and the PGW TEID (for downlink traffic) is not performed by each existing traffic transmitter, but the MME 20, which is the traffic controller, performs and centrally manages the allocation, thereby making it possible to reduce signaling after an attach completion.

Hereinafter, an initial attach procedure in the SDN based LTE core network will be described below with reference to FIG. 5.

The UE 15 transmits Attach Request 500, which is an NAS message, to the MME 20 for initial attach. The MME 20 allocates EPS bearer identifier (EPS Bearer ID Allocation) 502), and allocates the eNB TEID, SGW TEIDs, and the PGW TEID, which are tunnel identifiers for traffic transmission between the eNB 10 and the SGW(OFS) 11 or between the SGW(OFS) 11 and the PGW(OFS)(504). Next, the MME 20 request the GW controller 21 to create a session (Create Session Request) 506, and may transmit the previously allocated eNB TEID, SGW TEIDs, and PGW TEID, the eNB IP address, the IMSI of the UE 15, the EPS bearer ID, the QoS profile information to which the UE 15 subscribes, and the like, to the GW controller 21.

Next, if the GW controller 21 transmits an OFS Allocation Request 508 to the SDN controller 24, the SDN controller 24 performs a PCRF interworking 510 and allocates the OFS (OFS Allocation) 512 to transmit an OFS Allocation Response 514 to the GW controller 21. At the time of the OFS Allocation Request 508, the GW controller 21 may transmits the eNB TEID, the SGW TEIDs, and the PGW TEID, the eNB IP address, the IMSI, the UE IP address, the eNB ID, and the EPS bearer ID information received from the MME 20 to the SDN controller 24. In addition, at the time of the OFS Allocation Response 514, the GW controller 21 may receive the OFS IP address and the authenticated QoS profile information from the SDN controller 24. The GW controller 21 receiving the OFS IP address performs a UE IP address allocation 516, and transmits a Create Session Response 520 to the MME 20. The Create Session Response 520 may include the UE IP address, the EPS bearer ID and the authenticated QoS profile information. The SDN controller 24 updates a forward table (Update Forward Table) 518 while transmitting the eNB TEID, the SGW TEIDs, the PGW TEID, the eNB IP address, and the QoS profile information to the SGW(OFS) 11 (518).

The MME 20 receiving the Create Session Response message 520 transmits an Attach Accept 522 message to the UE 15 via the eNB 10 through an Initial Context Setup Request message 524, which is an S1AP message. In this case, the UE IP address, the EPS bearer ID and the QoS profile information are transmitted to the UE 15, and the eNB TEID (for downlink traffic), the SGW TEID (for uplink traffic), and the SGW IP address information are transmitted to the eNB 10.

Next, the eNB 10 establishes a radio bearer with the UE 15 (526), and establishes an uplink and downlink tunnel for traffic transmission with the SGW(OFS) 11 (528). Thereafter, the eNB 10 transmits an Initial Context Setup Response message 529, which is an S1AP message, to the MME 20. In the case of existing tunnel identifier exchange scheme, the MME 20 needs to transmit the eNB TEID received from the eNB 10 through a Modify Bearer Request message, to the SGW(OFS) 11 through the SDN controller 24, but this part of the procedure is unnecessary in the present invention. Finally, the UE 15 transmits an Attach complete 530 message to the MME 20.

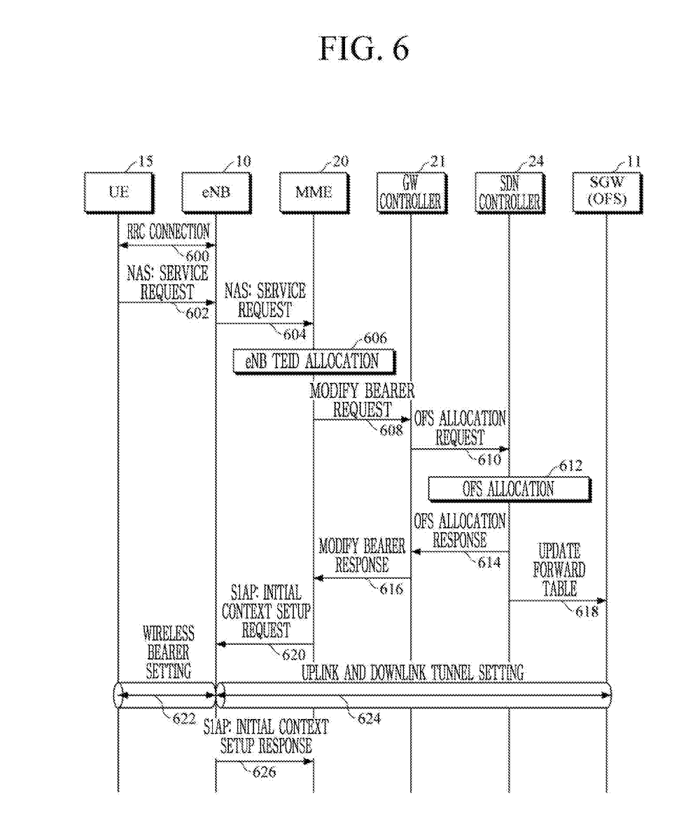

FIG. 6 is a flowchart illustrating a call flow of the SDN based mobile communication core network at the time of Service Request of a UE according to another exemplary embodiment of the present invention.

The process of FIG. 6 may be applied to the core network structure described above with reference to FIG. 1. Referring to FIG. 6, after an RRC connection 600 is performed between the UE 15 and the eNB 10, the UE 15 transmits a Service Request 602, 604, which is an NAS message, to the MME 20 through the eNB 10. The MME 20 receiving the Service Request 604 allocates the eNB TEID (for downlink traffic), which is a tunnel identifier for user traffic transmission between the eNB 10 and the SGW(OFS) 11 or between the SGW(OFS) 11 and the PGW(OFS) (606).

Next, the MME 20 requests the GW controller to modify a bearer (Modify Bearer Request) 608, and in this case, the IMSI of the UE 15, the EPS bearer ID, and the eNB TEID may be transmitted to the GW controller 21.

Next, if the GW controller 21 transmits an OFS Allocation Request 610 to the SDN controller 24, the SDN controller 24 allocates the OFS (OFS Allocation) 612 to transmit an OFS Allocation Response 614 to the GW controller 21. At the time of the OFS Allocation Request 608, the GW controller 21 may transmits the eNB TEID for downlink traffic, the SGW TEID for uplink and downlink traffic, and the PGW TEID for uplink traffic, the IMSI, the UE IP address, the eNB ID, and the EPS bearer ID information to the SDN controller 24. In addition, at the time of the OFS Allocation Response 614, the GW controller 21 may receive the OFS IP address and the authenticated QoS profile information from the SDN controller 24. The GW controller 21 receiving the OFS IP address transmits a Modify Bearer Response 616 to the MME 20. The Modify Bearer Response 616 may include the UE IP address, the EPS bearer ID, and the SGW(OFS) IP address. The SDN controller 24 updates a Forward Table (Update Forward Table) while transmitting the eNB TEID, the SGW TEIDs, the PGW TEID, the eNB IP address, and the QoS profile information to the SGW(OFS) 11 (618).

The MME 20 receiving the Modify Bearer Response message 616 transmits an Initial Context Setup Request message 620, which is an S1AP message, to the eNB 10. In this case, the MME 20 may simultaneously transmit the eNB TEID for downlink traffic, the SGW TEID for uplink traffic, and the SGW IP address to the eNB 10.

Next, the eNB 10 establishes a radio bearer with the UE 15 (622), and establishes an uplink and downlink tunnel for traffic transmission with the SGW(OFS) 11 (624). Thereafter, the eNB 10 transmits an Initial Context Setup Response message 626, which is an S1AP message, to the MME 20.

According to an embodiment of the present invention, it is possible to solve a non-flexibility problem in the complexity of the signaling processing and the network failure processing due to the separation of the data plane and the control plane according to a basic concept of the SDN in the SDN based mobile communication core network structure. In particular, a tunnel for transmitting a traffic in the SDN based next-generation mobile communication core network is allocated and centrally managed in the control plane, thereby making it possible to effectively perform the signaling processing and the network failure processing.

Hereinabove, the present invention has been described with reference to the exemplary embodiment thereof. It will be understood by those skilled in the art that the present invention may be embodied in modified forms without departing from the essential characteristics of the present invention. Therefore, the exemplary embodiments disclosed herein should be considered in an illustrative aspect rather than a restrictive aspect. The scope of the present invention is set forth in the appended claims rather than the foregoing description, and it should be construed that all differences within an equivalent scope of the claims are included in the present invention.

What is claimed is:

1. A signaling method in a mobile communication core network, the signaling method comprising:
receiving, by a traffic controller, an initial attach request from a terminal in a software defined network (SDN) based mobile communication core network;
allocating, by the traffic controller, a tunnel identifier for a tunnel establishment between a base station and a traffic transmitter or between traffic transmitters according to the initial attach request of the terminal; and
transmitting, by the traffic controller, the allocated tunnel identifier to the traffic transmitter and the base station.

2. The signaling method of claim 1, wherein:
the traffic controller includes an edge unified control entity or a mobility management entity, and
the traffic transmitter is an openflow switch.

3. The signaling method of claim 1, wherein: in the allocating of the tunnel identifier,
the traffic controller allocates a tunnel identifier for downlink traffic and a tunnel identifier for uplink traffic between the base station and the traffic transmitter, respectively.

4. The signaling method of claim 1, wherein:
the traffic controller includes an edge unified control entity and a SDN controller, and
the signaling method in the mobile communication core network further includes
transmitting, by the edge unified control entity allocating the tunnel identifier, a traffic transmitter allocation request including uplink and downlink tunnel identifiers to the SDN controller;
allocating, by the SDN controller, the traffic transmitter; and
receiving, by the edge unified control entity, a traffic transmitter allocation response including information on the allocated traffic transmitter from the SDN controller.

5. The signaling method of claim 4, further comprising:
updating, by the SDN controller allocating the traffic transmitter, a forward table, while transmitting the uplink and downlink tunnel identifiers received from the edge unified control entity to the traffic transmitter.

6. The signaling method of claim 4, further comprising:
transmitting, by the edge unified control entity receiving the traffic transmitter allocation response, previously allocated uplink and downlink tunnel identifier information to the base station.

7. The signaling method of claim 1, wherein:
the traffic controller includes a mobility management entity, a gateway controller, and a SDN controller, and
the signaling method in the mobile communication core network further includes:
transmitting, by the mobility management entity, a create session request including uplink and downlink tunnel identifiers to the gateway controller; and
receiving, by the mobility management entity, a create session response from the gateway controller.

8. The signaling method of claim 7, further comprising:
transmitting, by the mobility management entity receiving the create session response, uplink and downlink tunnel identifier information to the base station.

9. The signaling method of claim 1, wherein:
the traffic controller includes a mobility management entity, a gateway controller, and a SDN controller, and
the signaling method in the mobile communication core network further includes:
receiving, by the gateway controller, a create session request including a tunnel identifier from the mobility management entity;
requesting, by the gateway controller receiving the create session request, a traffic transmitter allocation while transmitting the tunnel identifier to the SDN controller; and
receiving, by the gateway controller, a traffic transmitter allocation response from the SDN controller, when the SDN controller allocates the traffic transmitter.

10. The signaling method of claim 9, further comprising:
updating, by the SDN controller allocating the traffic transmitter, a forward table, while transmitting the tunnel identifier received from the gateway controller to the traffic transmitter.

11. A signaling method in the mobile communication core network, the signaling method comprising:
receiving, by a traffic controller, a service request through a base station from a terminal in a software defined network (SDN) based mobile communication core network;
allocating, by the traffic controller, a tunnel identifier for a tunnel establishment between a base station and a traffic transmitter or between traffic transmitters in response to the service request of the terminal; and
transmitting, by the traffic controller, the allocated tunnel identifier to the traffic transmitter and the base station to which a traffic is to be transmitted.

12. The signaling method of claim 11, wherein:
the traffic controller includes an edge unified control entity and a SDN controller, and
the signaling method in the mobile communication core network further includes:
transmitting, by the edge unified control entity allocating uplink and downlink tunnel identifiers, a traffic transmitter allocation request including the uplink and downlink tunnel identifiers to the SDN controller;
allocating, by the SDN controller, the traffic transmitter; and
receiving, by the edge unified control entity, a traffic transmitter allocation response including information on the allocated traffic transmitter from the SDN controller.

13. The signaling method of claim 12, further comprising:
updating, by the SDN controller allocating the traffic transmitter, a forward table, while transmitting the uplink and downlink tunnel identifiers to the traffic transmitter.

14. The signaling method of claim 12, further comprising:
transmitting, by the edge unified control entity receiving the traffic transmitter allocation response, uplink and downlink tunnel identifier information to the base station.

15. The signaling method of claim 11, wherein:
the traffic controller includes a mobility management entity, a gateway controller, and a SDN controller, and
the signaling method in the mobile communication core network further includes:
transmitting, by the mobility management entity, a modify bearer request including the tunnel identifier to the gateway controller;
requesting, by the gateway controller receiving the modify bearer request, a traffic transmitter allocation while transmitting the tunnel identifier to the SDN controller;
allocating, by the SDN controller, the traffic transmitter; and
receiving, by the gateway controller, a traffic transmitter allocation response from the SDN controller.

16. The signaling method of claim 15, further comprising:
updating, by the SDN controller allocating the traffic transmitter, a forward table, while transmitting the tunnel identifier received from the gateway controller to the traffic transmitter.

17. A mobile communication core network system comprising:
a traffic controller receiving an initial attach request or a service request from a terminal in a software defined network (SDN) based mobile communication core network and allocating a tunnel identifier for a tunnel establishment between a base station and a traffic transmitter or between traffic transmitters; and
the traffic transmitter receiving the allocated tunnel identifier from the traffic controller and transmitting a traffic through the tunnel.

18. The mobile communication core network system of claim 17, wherein: the traffic controller includes
an edge unified control entity each allocating a tunnel identifier for downlink traffic and a tunnel identifier for uplink traffic between the base station and the traffic transmitter according to the initial attach request or the service request of the terminal; and
a SDN controller receiving a traffic transmitter allocation request including the uplink and downlink tunnel identifiers from the edge unified control entity, allocating the traffic transmitter, and transmitting a traffic transmitter allocation response to the edge unified control entity.

19. The mobile communication core network system of claim 17, wherein: the traffic controller includes
a mobility management entity each allocating a tunnel identifier for downlink traffic and a tunnel identifier for uplink traffic between the base station and the traffic transmitter according to the initial attach request of the terminal;
a gateway controller receiving a create session request including the tunnel identifier from the mobility management entity and allocating an IP address of the terminal to transmit a create session response to the mobility management entity; and
a SDN controller receiving a traffic transmitter allocation request from the gateway controller and allocating the traffic transmitter to control the traffic.

20. The mobile communication core network system of claim 17, wherein: the traffic controller includes
a mobility management entity allocating a tunnel identifier for downlink traffic between the base station and the traffic transmitter according to the service request of the terminal;
a gateway controller receiving a modify bearer request including the tunnel identifier from the mobility management entity and transmitting a modify bearer response including an IP address of the terminal to the mobility management entity; and
a SDN controller receiving a traffic transmitter allocation request from the gateway controller and allocating the traffic transmitter to control the traffic.
